(19) United States
(12) Patent Application Publication
(10) Pub. No.: US 2012/0075206 A1
(43) Pub. Date: Mar. 29, 2012

(54) MOTION DETECTING DEVICE, RECORDING SYSTEM, COMPUTER READABLE MEDIUM, AND MOTION DETECTING METHOD

(75) Inventors: Hideto YUZAWA, Yokohama-shi (JP); Tomoyuki Shoya, Yokohama-shi (JP); Hitoshi Ikeda, Yokohama-shi (JP); Takayuki Takeuchi, Ebina-shi (JP); Tsutomu Ishii, Ebina-shi (JP)

(73) Assignee: FUJI XEROX CO., LTD., Tokyo (JP)

(21) Appl. No.: 13/007,233

(22) Filed: Jan. 14, 2011

(30) Foreign Application Priority Data
Sep. 24, 2010 (JP) 2010-214076

(51) Int. Cl. G06F 3/03

(52) U.S. Cl. 345/173

(57) ABSTRACT

A motion detecting device includes: a first detecting unit that detects a state of a writing hand of a writer based on first data output depending on the state of the writing hand from a first sensor; a second detecting unit that detects a distance between the writer and a recording medium based on second information output from a second sensor; a determining unit that determines that the writer is writing on the recording medium when the state of the writing hand detected by the first detecting unit is a predetermined state and the distance detected by the second detecting unit is smaller than or equal to a predetermined threshold value; and an output data generating unit that generates output data based on a state of the writer determined by the determining unit.

### CROSS-REFERENCE TO RELATED APPLICATIONS

This application is based on and claims priority under 35 USC 119 from Japanese Patent Application No. 2010-214076 filed on Sep. 24, 2010.

### BACKGROUND

1. Technical Field

The present invention relates to a motion detecting device, a recording system, a computer readable medium, and a motion detecting method.

2. Related Art

A recording medium for recording information (character or image) written by hand, such as a so-called electronic blackboard, is known.

### SUMMARY

According to an aspect of the invention, there is provided a motion detecting device including: a first detecting unit that detects a state of a writing hand of a writer that holds a writing instrument, based on first data output depending on the state of the writing hand from a first sensor provided independently of the writing instrument; a second detecting unit that detects a distance between the writer and a recording medium on which information is written by the writer, based on second information output from a second sensor provided independently of the recording medium; a determining unit that determines that the writer is writing on the recording medium when the state of the writing hand detected by the first detecting unit is a predetermined state and the distance detected by the second detecting unit is smaller than or equal to a predetermined threshold value; and an output data generating unit that generates output data based on a state of the writer determined by the determining unit.

### BRIEF DESCRIPTION OF THE DRAWINGS

Exemplary embodiments of the present invention will now be described in detail based on the following figures, wherein:

FIG. 1 is a schematic diagram showing the inside of a room;

FIG. 2 is a block diagram showing an entire configuration of a recording system;

FIG. 3 is a block diagram showing a hardware configuration of an information-processing device;

FIG. 4 is a functional block diagram showing a functional configuration of an information-processing device;

FIG. 5 is a flowchart showing data record processing performed by an information-processing device;

FIG. 6 is a flowchart showing data search processing performed by an information-processing device;

FIG. 7 is a diagram showing an example of a screen displayed on a display in data search processing; and

FIG. 8 is a diagram showing an example of a screen displayed on a display in data search processing.

### DETAILED DESCRIPTION

### Exemplary Embodiment

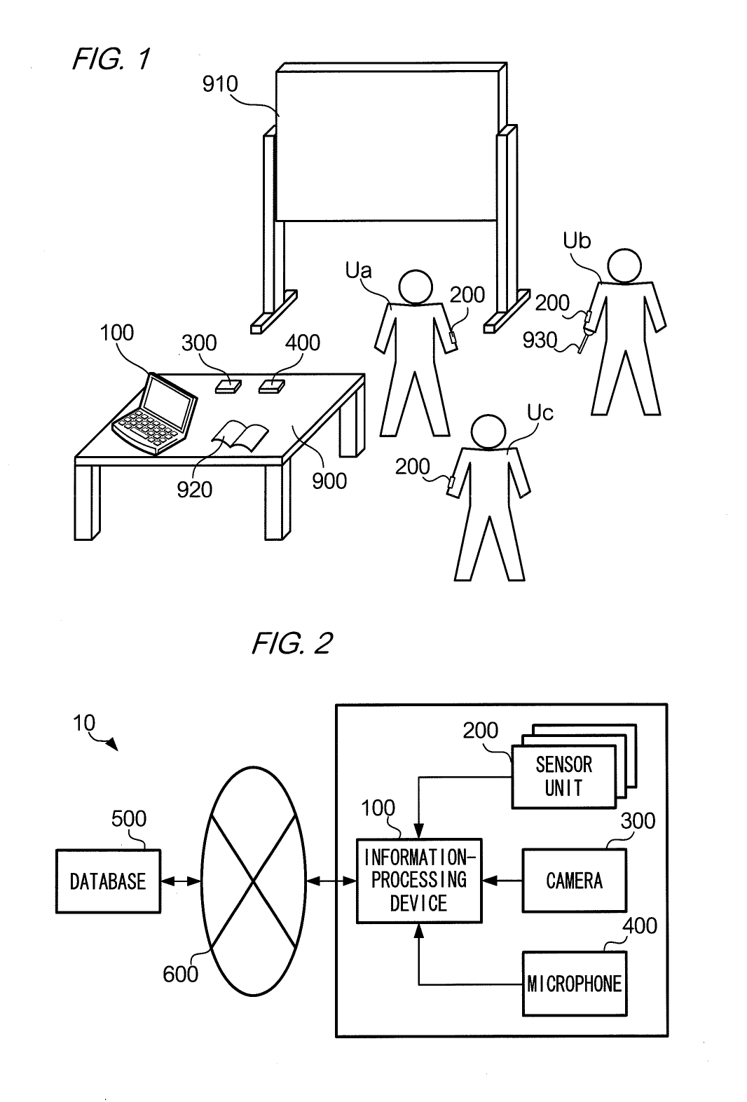

FIG. 1 is a schematic diagram showing the inside of a room, such as a meeting room in an office, according to an exemplary embodiment of the present invention. As shown in FIG. 1, there are plural users Ua, Ub, and Uc in the room. Whiteboard 910 and table 900 are disposed in the room. Information-processing device 100, camera 300, microphone 400, and notebook 920 are placed on table 900.

Whiteboard 910 is a recording medium on which information is written by users Ua, Ub, or Uc using writing instrument 930. Whiteboard 910 has a recording surface onto which information is written, and is fixed so that the recording surface is substantially vertical with respect to a floor of the room. On the other hand, notebook 920 is also a recording medium onto which information is written by users Ua, Ub, or Uc, but a recording surface of notebook 920 is more horizontal than the recording surface of whiteboard 910. Since notebook 920 is placed on table 900, which has a horizontal tabletop, notebook 920 is maintained in such a state. Whiteboard 910 corresponds to an example of a first recording medium according to the present invention, and notebook 920 corresponds to an example of a second recording medium according to the present invention.

It is to be noted that the recording surface of whiteboard 910 does not have to be exactly vertical with respect to the floor. Whiteboard 910 may be inclined to any vertical direction from the direction of inclination of the recording surface of notebook 920. In other words, the recording surface of whiteboard 910 is more vertical than the recording surface of notebook 920, and the recording surface of notebook 920 is more horizontal than the recording surface of whiteboard 910.

Writing instrument 930 is an instrument for writing information. Any one of users Ua, Ub, and Uc holds and uses writing instrument 930. Writing instrument 930 is, for example, a pen with a water-based ink. It is to be noted that writing instrument 930 for writing on whiteboard 910 (for example, a whiteboard marker) and writing instrument 930 for writing in notebook 920 (for example, a pencil or a ballpoint pen) may be provided separately. Preferably, a coloring material (such as a pigment or an ink) of writing instrument 930 is a coloring material that allows removal of information that has been written on whiteboard 910 or in notebook 920.

Users Ua, Ub, and Uc are people who write information on whiteboard 910 or in notebook 920. Each of users Ua, Ub, and Uc wears sensor unit 200. Sensor units 200 output a variety of information related to each of users Ua, Ub, and Uc. In this exemplary embodiment, sensor unit 200 has a shape like a wristwatch or bracelet to be worn around a wrist of a forearm.

In the following description, user Ua, Ub, and Uc may be collectively referred to as “user U,” except where it is necessary to specify a user. In addition, a person who is writing or is about to write information on whiteboard 910 or in notebook 920 is referred to as a “writer” when the person is distinguished from other users U. The total number of users U is not limited to a case shown in the drawing (namely, three), and there may be any number of users.

FIG. 2 is a block diagram showing an entire configuration of recording system 10 according to the present exemplary embodiment. Recording system 10 includes information-processing device 100 described above, sensor unit 200, camera 300, and microphone 400, in addition to database 500, and network 600. Database 500 and network 600 do not have to be provided in the room.

Information-processing device 100 communicates with sensor unit 200, camera 300, microphone 400, and database 500 to record information related to user U (information related to writing). Information-processing device 100 determines a state of user U related to writing by receiving data from sensor unit 200, camera 300 and microphone 400, and performs processing based on the determined state. As an example of such a processing, information-processing device 100 generates information related to writing carried out by user U, and transmits the information to database 500. Information-processing device 100 is, for example, a personal computer (PC).

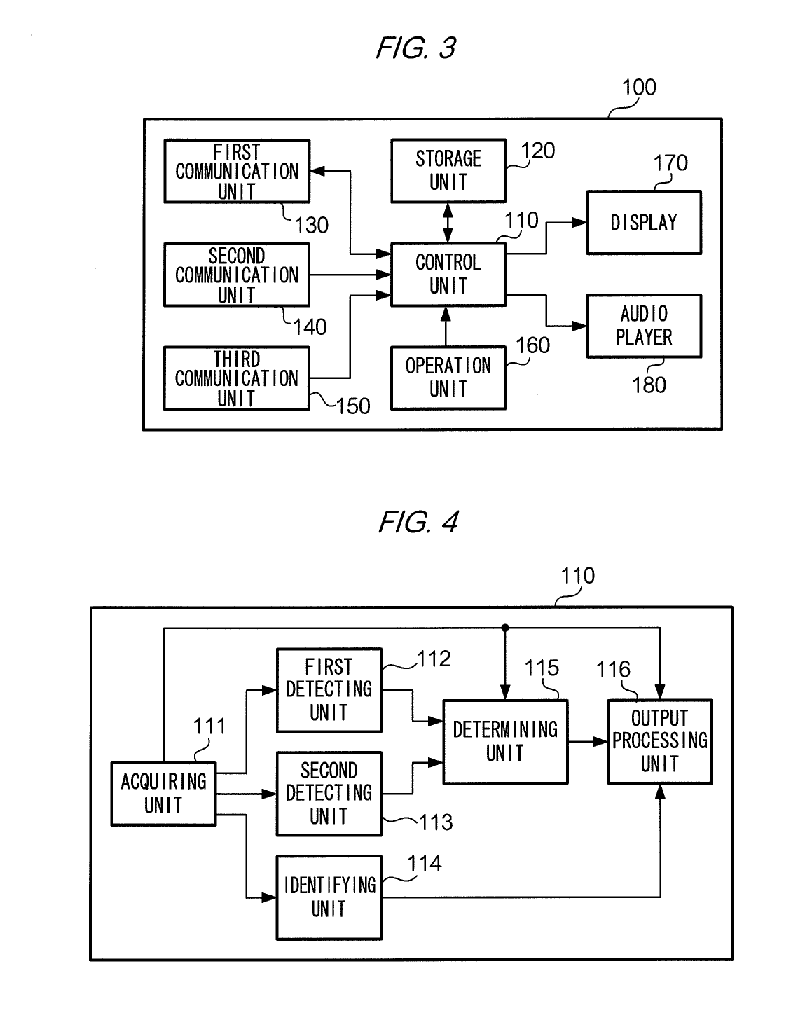

FIG. 3 is a block diagram showing a hardware configuration of information-processing device 100. As shown in FIG. 3, information-processing device 100 includes control unit 110, storage unit 120, first communication unit 130, second communication unit 140, third communication unit 150, operation unit 160, display 170, and audio player 180.

Control unit 110 is a unit for controlling an operation of each unit of information-processing device 100. Control unit 110 includes a processor such as a Central Processing Unit (CPU), and a memory serving as a main memory.

Control unit 110 serves as a motion-detecting device according to the present invention by executing a program. When serving as the motion-detecting device, control unit 110 generates status data representing a state of user U, and outputs the status data. Storage unit 120 includes a storage serving as an auxiliary storage such as a hard disk to store data (including programs) used by control unit 110. Details of the status data will be described later.

First communication unit 130 is a unit for connecting to network 600 to communicate with database 500. Second communication unit 140 is a unit for communicating with sensor unit 200. Third communication unit 150 is a unit for communicating with camera 300 and microphone 400. Preferably, second communication unit 140 is capable of performing wireless communication to prevent hindrance of movement of user U. On the other hand, first communication unit 130 and third communication unit 150 may be either wired or wireless.

Operation unit 160 is a unit for receiving an operation input by an operator. Operation unit 160 provides data depending on an operation input by an operator (hereinafter referred to as “operation data”) to control unit 110. Operation unit 160, for example, includes a keyboard and a mouse. The operator may be any one of users U, or may be a person other than users U. Display 170 is a unit for displaying information. When display data is provided from control unit 110, display 170 displays a character and an image based on the display data. Display 170 is, for example, a liquid crystal display. However, display 170 may be a projector that projects an image on whiteboard 910 or a wall of a room. Audio player 180 is a unit for playing a sound. Audio player 180, for example, includes a speaker, and plays a sound based on sound data provided from control unit 110.

Sensor unit 200 is an integrated combination of plural sensors for acquiring information related to user U. More specifically, sensor unit 200 includes acceleration sensor 210, range sensor 220, pulse sensor 230, sweat sensor 240, and transmission unit 250. In this exemplary embodiment, acceleration sensor 210 corresponds to an example of a first sensor according to the present invention. Range sensor 220 corresponds to an example of a second sensor according to the present invention.

Acceleration sensor 210 outputs data depending on a state of a hand of a writer holding writing instrument 930. In the following description, data output from acceleration sensor 210 is referred to as acceleration data. In this exemplary embodiment, acceleration sensor 210 is a triaxial acceleration sensor to measure triaxial accelerations, which are perpendicular to each other. In the following description, a hand that holds writing instrument 930 (in this exemplary embodiment, namely, a part around a wrist of a forearm) is referred to as a writing hand, and it may be either a right hand or a left hand. In addition, an acceleration represented by acceleration data includes an acceleration depending on a motion of a writing hand of a writer, in addition to a gravitational acceleration. Acceleration data corresponds to an example of first data according to the present invention.

Range sensor 220 measures a distance between a writer and an object located near a writing hand of the writer. In the following description, data measured by and output from range sensor 220 is referred to as range data. Range data corresponds to an example of second data according to the present invention. In this exemplary embodiment, range sensor 220 emits an infrared ray, and receives a light reflected from an object (such as whiteboard 910) located in a direction in which the infrared ray is emitted, whereby range sensor 220 measures a distance between the sensor and the object. Accordingly, more strictly speaking, the term “distance between a writer and an object” refers to a distance between range sensor 220 and the object. Range sensor 220 is located in sensor unit 200 so that range sensor 220 faces whiteboard 910 when a writer writes on whiteboard 910.

Pulse sensor 230 measures a pulse rate of user U. In the following description, data measured by and output from pulse sensor 230 is referred to as pulse data. Sweat sensor 240 measures factors relating to sweating, such as an amount of sweat and sweat rate of a writer. In the following description, data measured by and output from sweat sensor 240 is referred to as sweating data. Sweat sensor 240 may be constructed so that sweat sensor 24 is attached to a position at which a factor relating to sweating is more easily measured (for example, a palm) instead of a wrist.

In addition, pulse sensor 230 and sweat sensor 240 may also perform a measurement while user U is not actually writing with writing instrument 930.

Transmission unit 250 transmits status data to information-processing device 100. Transmission unit 250 also transmits identification data for identifying a user U together with the status data. Transmission unit 250 may transmit acceleration data, range data, pulse data, and sweating data (or any of these data) together with the status data and identification data. In the following description, data transmitted by transmission unit 250 is collectively referred to as “user data.” Transmission unit 250, for example, communicates with information-processing device 100 in a method based on a predetermined wireless communication standard, such as Bluetooth™. When Bluetooth is used, identification data for identifying user U, for example, corresponds to a so-called PIN code (also called passkey). Of course, other data may be used as identification data.

Camera 300 takes an image of a recording surface of whiteboard 910, and transmits image data thus acquired to information-processing device 100. Camera 300 may be a unit for taking a still photograph, or may be a unit for recording a moving image. Camera 300 acquires information written on whiteboard 910 as image data. In other words, camera 300 corresponds to an example of an acquiring unit according to the present invention. Preferably, camera 300 has such a resolution that a character written on the recording surface of whiteboard 910 is legible based on image data acquired by taking an image. Microphone 400 receives a sound inside a room, and transmits sound data to information-processing device 100. It is to be noted that camera 300 and microphone 400 may be integrated, or may be a part of information-processing device 100. Also, for example, a mobile phone with a camera having a wired or wireless connection with information-processing device 100 may be used as camera 300 and microphone 400.

Network 600 is a communication network for connecting information-processing device 100 and database 500. Network 600 is, for example, the Internet or a Local Area Network (LAN).

Database 500 stores user data, image data transmitted from camera 300, and sound data transmitted from microphone 400. Database 500 also has a search function for searching these data and outputting retrieved data. By this function, on request from information-processing device 100 or another computer device, necessary data is retrieved from user data, image data, and sound data and is outputted. Database 500 corresponds to an example of a memory according to the present invention.

The foregoing is a description of a hardware configuration of recording system 10. With this configuration, recording system 10 determines and records a state of user U. The state of user U includes at least a state of a writer related to writing, but the state may also include a state unrelated to writing (for example, a state in which user U does not do anything, or a state in which user U points at whiteboard 910). Information-processing device 100 determines and records the state of user U.

FIG. 4 is a functional block diagram showing a functional configuration of information-processing device 100. Control unit 110 of information-processing device 100 provides functions of acquiring unit 111, first detecting unit 112, second detecting unit 113, identifying unit 114, determining unit 115, and output processing unit 116 shown in FIG. 4 by executing a program stored in advance.

Acquiring unit 111 acquires data output from sensor unit 200 via second communication unit 140. Namely, acquiring unit 111 acquires acceleration data, range data, pulse data, sweating data, and identification data. Acquiring unit 111 also acquires data output from camera 300 and microphone 400 via third communication unit 150. Namely, acquiring unit 111 acquires image data and sound data.

First detecting unit 112 detects a state of a writing hand (a hand to which sensor unit 200 is attached) of user U using acceleration data acquired by acquiring unit 111. In this exemplary embodiment, a state of a writing hand detected by first detecting unit 112 includes an angle of inclination of the writing hand with respect to the vertical direction, and a writing motion. The angle of inclination of a writing hand with respect to the vertical direction is detected on the basis of a direction of a gravitational acceleration identified by acceleration data. The writing motion is detected on the basis of whether the acquired data corresponds to a predetermined pattern. First detecting unit 112 corresponds to an example of a first detecting unit according to the present invention.

Second detecting unit 113 detects a distance between a writing hand of user U and an object located near the writing hand using range data acquired by acquiring unit 111. In this exemplary embodiment, the object located near a writing hand of user U is, for example, whiteboard 910 or notebook 920. However, second detecting unit 113 may detect a distance between a writing hand and an object other than a recording medium (whiteboard 910 or notebook 920). Second detecting unit 113 corresponds to an example of a second detecting unit according to the present invention.

In addition, second detecting unit 113 may have improved detection ability by having a function of recognizing a color of a recording medium (whiteboard 910 or notebook 920), or a mark put on the recording medium in advance, for distinguishing the recording medium from an object other than the recording medium.

Identifying unit 114 identifies user U who is the subject detected by first detecting unit 112 and second detecting unit 113. Identifying unit 114 identifies user U using identification data acquired by acquiring unit 111. Identifying unit 114 may only distinguish a subject user from other users, but identifying unit 114 also may store a relationship between identification data and information on user U (such as a name) in advance, and identify the subject user U. The relationship may be stored in storage unit 120, and identifying unit 114 (namely, control unit 110) may retrieve the relationship from storage unit 120 as needed. Identifying unit 114 corresponds to an identifying unit according to the present invention.

Determining unit 115 determines a state of user U using at least results detected by first detecting unit 112 and detecting unit 113. In this exemplary embodiment, determining unit 115 determines a state of user U using the results detected by first detecting unit 112 and detecting unit 113, in addition to using user U identified by identifying unit 114, and pulse data and sweating data acquired by acquiring unit 111. Determining unit 115 determines a state including a state of a writer related to writing. Determining unit 115 corresponds to an example of a determining unit according to the present invention.

In this exemplary embodiment, the state of user U determined by determining unit 115 is any one of 5 states of “writing on whiteboard 910 in a nervous condition (state 1),” “writing on whiteboard 910 in a relaxed condition (state 2),” “writing in notebook 920 (state 3),” “standing near whiteboard 910 without writing but with writing hand raised (state 4),” and “any other state (state 5).” State 4, namely “standing near whiteboard 910 without writing but with writing hand raised,” refers to a state in which user U is not writing any information, but, for example, is about to write on whiteboard 910 or is pointing at whiteboard 910. State 5, namely “any other state,” for example, refers a state in which user U makes remarks, listens to remarks made by another user U, or reads information written on whiteboard 910. After determining a state of user U as described above, determining unit 115 provides status data depending on the determined state to output processing unit 116. For example, determining unit 115 provides status data “1” if state 1 is determined, or determining unit 115 provides status data “2” if state 2 is determined.

Output processing unit 116 performs output processing based on the result determined by determining unit 115. In this exemplary embodiment, output processing based on the result determined by determining unit 115 includes at least processing to generate and output data, and to record the data to database 500. Also, when performing output processing based on the result determined by the determining unit 115, output processing unit 116 may inform the determined result to an operator or user U by displaying the determined result on display 170 as an image, or by outputting a sound from audio player 180. Output processing unit 116 corresponds to an example of an output data-generating unit according to the present invention.

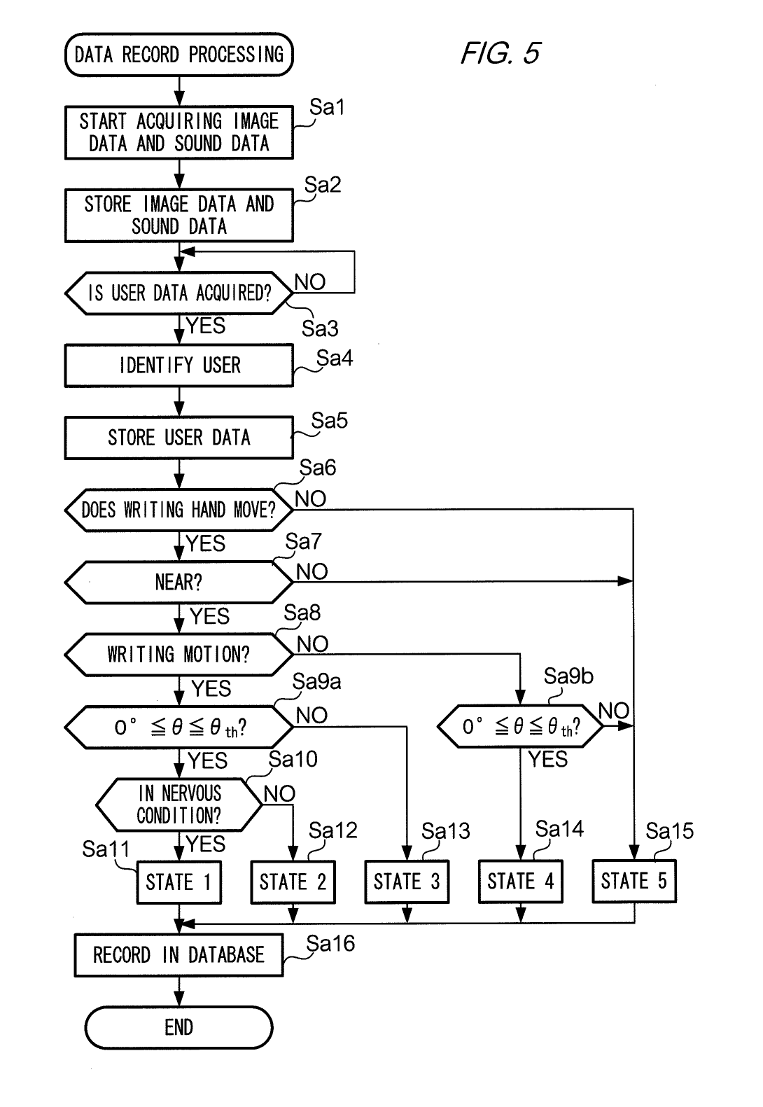

FIG. 5 is a flowchart showing processing performed by an information-processing device 100 to record data to database 500 (hereinafter referred to as “data record processing”). In this data record processing, control unit 110 of information-processing device 100 firstly starts acquiring image data and sound data output from camera 300 and microphone 400, via third communication unit 150 (step Sa1), and sequentially stores the data in storage unit 120 temporarily (step Sa2). Control unit 110 continues to temporarily store the data until image data and sound data are no longer provided.

Control unit 110 then determines whether user data is acquired via second communication unit 140 (step Sa3). If sensor unit 200 has moved in a range enabling communication, or alternatively sensor unit 200 is powered on by user U, information-processing device 100 starts receiving user data. Upon acquiring user data, control unit 110 identifies user U based on identification data included in the user data (step Sa4), and temporarily stores the user data in storage unit 120 in association with information on the identified user U (step Sa5).

Control unit 110 then detects a motion of a writing hand of user U based on acceleration data included in the user data, and determines whether the writing hand moves (step Sa6). Specifically, control unit 110 identifies an acceleration other than a gravitational acceleration from the acceleration data, and determines whether a writing hand is raised or lowered, or is vibrated slightly. For example, if an acceleration greater than a predetermined threshold value other than a gravitational acceleration is identified during a predetermined time, control unit 110 determines that a writing hand moves.

When determining that a writing hand moves (step Sa6: YES), control unit 110 determines whether the writing hand is located near an object (such as whiteboard 910, notebook 920, or table 900) based on range data included in the user data (step Sa 7). Specifically, control unit 110 determines whether a distance detected from range data is smaller than or equal to a predetermined threshold value. In this exemplary embodiment, the threshold value related to a distance between a writing hand and an object is a value deemed to indicate that a user moves the writing hand to the object so as to write. For example, the threshold value is greater than or equal to 5 cm and smaller than or equal to 30 cm.

When determining that the distance detected from range data is smaller than or equal to the predetermined threshold value (step Sa7: YES), control unit 110 determines whether a data pattern representing a writing motion is detected from acceleration data (step Sa8). Here, the term “data pattern representing a writing motion” refers to a characteristic data pattern that appears when a writer is writing on a recording medium. In the data pattern, for example, acceleration is detected in short movements up and down in the horizontal direction or vertical direction. The data pattern is predetermined based on recorded writing motions of plural writers and statistical processing is performed. If the data pattern representing the writing motion has been detected, control unit 110 deems that user U is a writer, and is writing on whiteboard 910 or in notebook 920.

In both a case where the data pattern representing the writing motion has been detected (step Sa8: YES), and a case where the data pattern representing a writing motion has not been detected (step Sa8: NO), control unit 110 determines an angle of inclination of the writing hand of the writer based on a direction of a gravitational acceleration identified from the acceleration data (step Sa9a). In this exemplary embodiment, control unit 110 determines to what extent a writing hand is inclined in the vertical direction. In the following description, an angle of an inclination of a writing hand is described as “θ.” Here, the inclination θ refers to an angle of a forearm of a writing hand with respect to the vertical direction. If inclination θ is 0 degree, a forearm is deemed to be parallel to the vertical direction. If inclination θ is 90 degrees, the forearm is deemed to be parallel to the horizontal direction.

If inclination θ satisfies the condition 0°≦θ≦θₜₕ, control unit 110 determines that the writing hand is approximately vertical. If inclination θ satisfies the condition θ>θₜₕ, control unit 110 determines that the writing hand is approximately horizontal. Here, the threshold value θₜₕ is predetermined for inclination θ. Threshold value θₜₕ is, for example, greater than or equal to 30 degrees and smaller than or equal to 60 degrees approximately. Different writing styles are used by users U. Thus, it is preferred that threshold value θₜₕ has a relatively large value to support a wide range of individual differences. However, if threshold value θₜₕ increases to approximate 90 degrees, it is likely to lead to an erroneous determination that a state of writing in notebook 920 is a state of writing on whiteboard 910.

When the data pattern representing the writing motion has been detected (step Sa8: YES), and inclination θ satisfies the condition 0°≦θ≦θₜₕ (step Sa9a: YES), control unit 110 determines whether the writer is in a nervous condition based on pulse data and sweating data included in the user data (step Sa10). For example, if at least one of the pulse measurement determined by pulse data and the amount related to sweating determined by sweating data is greater than or equal to a predetermined threshold value, control unit 110 determines that the writer is in a nervous condition, but if not, control unit 110 determines that the writer is in a relaxed condition. Alternatively, control unit 110 may determine the writer is in a nervous condition if the pulse measurement is greater than or equal to a threshold value, and the amount related to sweating is also greater than or equal to a threshold value.

When determining that the writer is in a nervous condition (step Sa10: YES), control unit 110 determines that user U is in state 1, namely “state in which a writer is writing on whiteboard 910 in a nervous condition” (step Sa11). Meanwhile, when determining that the writer is in a relaxed condition (step Sa10: NO), control unit 110 determines that user U is in state 2, namely “state in which a writer is writing on whiteboard 910 in a relaxed condition” (step Sa12).

Meanwhile, when the data pattern representing the writing motion has been detected (step Sa8: YES), and inclination θ does not satisfy the condition 0°≦θ≦θₜₕ (step Sa9a: NO), since the writing hand is more horizontal than in a case of state 1, control unit 110 determines that the writer makes a writing motion, and is writing on a recording medium other than whiteboard 910. In this case, control unit 110 determines that user U is in state 3, namely “state in which a writer is writing in notebook 920” (step Sa13), because a recording surface of notebook 920 is more horizontal than that of whiteboard 910.

When the data pattern representing the writing motion has not been detected (step Sa8: NO), and inclination θ satisfies the condition 0°≦θ≦θₜₕ (step Sa9b: YES), control unit 110 determines that the writer makes no writing motion, but the writing hand is approximately vertical, namely the writer is in a state as for writing on whiteboard 910. In this case, control unit 110 determines that user U is in state 4, namely “state in which a writer stands near whiteboard 910 without writing but with writing hand raised” (step Sa14).

In any one of a case where control unit 110 determines that the writing hand makes no motion (step Sa6: NO), a case where control unit 110 determines that the distance detected from range data is greater than the predetermined threshold value (step Sa1: NO), and a case where the data pattern representing the writing motion has not been detected (step Sa8: NO) and inclination θ does not satisfy the condition 0°≦θ≦θₜₕ (step Sa9b: NO), control unit 110 determines that user U is in state 5, namely “any other state” (step Sa15).

After determining that user U is in any of states 1 to 5 as described above, control unit 110 retrieves the image data and sound data that are temporarily stored in storage unit 120, and outputs these data together with the identification data and state data to be recorded in database 500 (step Sa16). Control unit 110 may output to database 500 all of the image data and sound data stored in storage unit 120, but may output only a part of the data acquired when user U is in a specified state. For example, control unit 110 may output only a part of the image data and sound data to database 500 acquired when user U is writing on a recording medium (whiteboard 910 or notebook 920), namely, when user U is in any one of states 1, 2, and 3. In this case, control unit 110 may extract image data and sound data during a predetermined period and output only the extracted partial data to database 500, when a state of user U is determined as state 1, 2, or 3 (for example, during 10 minutes after determination, or 5 minutes before and 10 minutes after determination). Alternatively, control unit 110, for example, may output to database 500 data to be recorded that associates image data acquired at a time predetermined based on a time a state of user U is shifted from either state 1 or state 2 to a state other than state 1 and state 2, with identification data for the writer.

Also, in step Sa16, control unit 110 may record in database 500 not only the identification data and status data, but also other user data.

As described above, in recording system 10, when the above data recording processing is performed, image data and sound data depending on a state of user U are recorded in database 500. An operator receives and plays data recorded in database 500 by information-processing device 100 when needed. When an operator needs to look back or recall a meeting that took place in the room, the operator uses a search function of database 500 to retrieve necessary data, and plays information written on whiteboard 910 by user U or an audio recording of the meeting.

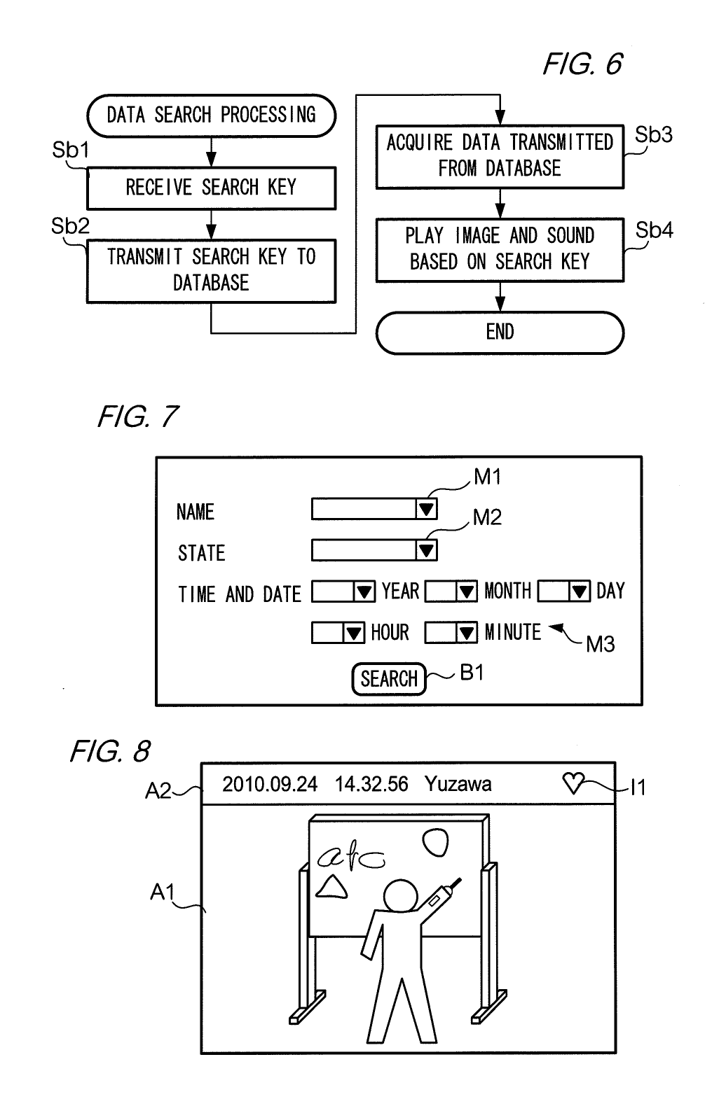

FIG. 6 is a flowchart showing processing related to a data search performed by information-processing device 100 (hereinafter referred to as “data search processing”). In this data search processing, control unit 110 of information-processing device 100 firstly receives a search key from an operator by acquiring operation data representing a search key from operation unit 160 (step Sb1). The search key is, for example, time, identification data, and status data. For example, if the operator requests audio content that recorded at a certain time, and information that was written on whiteboard 910 at that time, time is used as the search key. If the operator requests information that was written by a specified user U on whiteboard 910, identification data is used as the search key. If the operator requests information that was written on whiteboard 910 when specified user U is in a specified state (for example, in a nervous condition), a combination of identification data and status data are used as the search key.

Upon receiving the search key, control unit 110 transmits the search key to database 500 via first communication unit 130 (step Sb2). Upon receiving the search key, database 500 retrieves data (such as image data) corresponding to the search key, and transmits the data to information-processing device 100. Control unit 110 acquires the data transmitted from database 500 via first communication unit 130 (step Sb3), and plays an image on display 170 and a sound from audio player 180 (step Sb4). Also, control unit 110 may combine the searched image and audio content, and may play an image and audio content recorded in database 500 when a state of user U is determined as a specified state (for example, state 1) together, or alternatively may play an image and audio content acquired when a specified user U was writing on a recording medium.

FIGS. 7 and 8 are diagrams showing examples of screens displayed on display 170 in the data search processing. FIG. 7 is diagram showing an example of a screen that allows an operator to input the search key. In FIG. 7, if an operator searches an image and audio content related to a specified user U, the operator selects the name of the user using pull down menu M1. If the operator searches an image and audio content acquired when unspecified user U is in a specified state, the operator selects the state using pull down menu M2. If the operator searches an image and audio content acquired at a specified time and date, the operator selects the time and date using pull down menu M3. The search key is not limited to be input by use of a pull down menu, but it may be input using another Graphical User Interface (GUI) widget, such as a text box, or a radio button. After selecting a desired search key, the operator selects search button B1 by performing an operation such as clicking a mouse button. Upon receiving an instruction to select search button B1, information-processing device 100 transmits the selected search key to database 500. It is to be noted that if performing a so-called AND search (a search using a combination of plural search keys), information-processing device 100 receives plural search keys, and transmits a combination of the received plural search keys to database 500.

FIG. 8 is a diagram showing an example of an image played on display 170 in the data search processing. In FIG. 8, information-processing device 100 displays an image of whiteboard 910 and its surroundings in display area A1, and also displays a time and date and the name of user U in display area A2. In FIG. 8, icon I1 is an image representing a level of nervousness of a writer who is writing on whiteboard 910, and indicates a level of nervousness by changes in its appearance (such as a color differentiation, time interval of blinking, or a size). It is to be noted that information-processing device 100 may not display content in display area A2, and may display other information. For example, information-processing device 100 may display a state of every user U together with the name of each user U.

### Modification

An embodiment of the present invention is not limited to the above exemplary embodiment. For example, the exemplary embodiment may have the following modifications. The modifications may be combined with each other as needed.

### Modification 1

In the present invention, a state of a user (or a writer) is not limited to the state described in the above exemplary embodiment. For example, a state of a user may be determined by dividing a level of nervousness in three stages or five stages. A state in which a writer is writing information is not only a state in which the writer is actually writing (for example, above state 1, 2 and 3), but also includes a state in which the writer is about to write (for example, above state 4). More specifically, in the present invention, a state in which a writer is writing information is not only a case where the user is actually writing information, but also includes a case where it is highly probable that the user is about to start writing.

A state of a user may be a state unrelated to nervousness. In this case, states corresponding to above state 1 and state 2 are not distinguished from each other, and are regarded as a “state in which a writer is writing on whiteboard 910.” Also, in this case, configurations corresponding to above pulse sensor 230 and sweat sensor 240 are not required.

### Modification 2

Generally, writing styles are different among users, due to personal habits or differences in physique. For example, character writing speed and distance between a user and whiteboard 910 when a user writes on whiteboard 910 are different among users. Accordingly, information-processing device 100 may store a data pattern and threshold used when determining a state of user U, and differentiate a data pattern and threshold depending on a writer identified by identifying unit 114.

### Modification 3

In the above exemplary embodiment, output processing unit 116 serves as an example of an output processing unit according to the present invention. However, an output processing unit according to the present invention only has to execute output processing based on a result determined by a determination unit (for example, determining unit 115); the output processing does not have to be processing to record data. For example, the present invention may include output processing for outputting data representing a result determined by a determination unit (for example, status data) to an external device, and the external device may perform processing related to recording and searching of data.

### Modification 4

In the present invention, the first sensor and the second sensor do not have to be integrated. For example, the first sensor may be attached to a palm or the back of a hand, instead of a forearm, and the second sensor may be attached to the body of a user. The second sensor may be located at any position if the position is in a part of a body of the user or the user's clothing (but the position is preferably at the front), but it is required that the first sensor be located at such a position that the first sensor can detect a state of a writing hand. In addition, an angle detected as an angle indicating an inclination of a writing hand may be different, depending on where the sensor is attached. Therefore, it is preferable that threshold value θₜₕ set for an inclination of a writing hand be determined in relation to a position where the first sensor is attached.

The first sensor may be attachable to a writing instrument, instead of a user. In addition, the second sensor may be attachable to a writing medium (such as a whiteboard). In this case, the second sensor only has to be a sensor for detecting approach of a user. In both cases, it is preferable that the first sensor and second sensor is provided separately from a writing instrument and a recording medium (in other words, that can be separated). This is because, if the first sensor and the second sensor cannot be separated from the writing instrument and the recording medium, a writing instrument and recording medium available for implementing the present invention are limited. On the other hand, if the first sensor and the second sensor are provided separately from the writing instrument and the recording medium, an available writing instrument and recording medium are not limited. In addition, in a case where a user U switches between plural writing instruments, one sensor is sufficient regardless of the number of writing instruments.

Further, the first sensor and the second sensor may be shared by passing one sensor along between users, instead of providing a separate sensor for each user. In this case, the first sensor and the second sensor are preferably integrated in the same way as sensor unit 200 described in the above exemplary embodiment. In the above exemplary embodiment, in a case where plural users share one sensor unit 200, a section for specifying a user who uses sensor unit 200 (such as a button) may be provided on the unit, or alternatively an operator of information-processing device 100 confirms a user, and may input information on a user currently using sensor unit 200 via operation unit 160. It is to be noted that an identification unit according to the present invention may identify a user based on operation data provided from operation unit 160 as described.

### Modification 5

A motion detecting device according to the present invention may be integrated with at least one of a first sensor and a second sensor. In other words, a motion detecting device according to the present invention may be built into a device attached to user U as sensor unit 200 described in the above exemplary embodiment. In a case where the above exemplary embodiment is modified in this modification, an output-processing unit, for example, serves as a unit for performing processing to output status data to information-processing device 100.

### Modification 6

A recording medium according to the present invention may include a configuration for storing information written by a user (namely, a write path) and for transmitting the information to an external device, such as an information-processing device. When employing such a recording medium, since the recording medium includes a configuration serving as above camera 300, the configuration does not have to be provided separately. For example, a whiteboard having a function for optically reading a recording surface, or a display device having a function for recognizing handwriting of a user via a touch screen (a touch panel) provided on a recording surface (a so-called tablet PC or electronic paper) can be employed as such a recording medium.

### Modification 7

In the present invention, an image-capturing unit for taking an image of a recording medium, and a sound receiving unit for receiving a sound are not indispensable. Such an image-capturing unit and sound receiving unit may be implemented by a mobile terminal such as a mobile phone. In a case where a mobile terminal serves as the image-capturing unit and sound receiving unit, each user may carry the mobile phone individually, and may record an image and sound personally needed. In this case, taking an image and receiving a sound may be started and ended by an operation performed by a user.

### Modification 8

The present invention may be implemented as a motion detecting device, an information-processing device including the motion detecting device, a recording system including the information-processing device and a database, or a recording method thereof A memory corresponding to a database according to the present invention may be included in an information-processing device, or may be connected to an information-processing device without a network. Also, the present invention may be provided as a program for causing a computer to serve as a motion detecting device, or may be provided as a recording medium that records the program. A program according to the present invention may be downloaded to a computer via a communication line such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments have been chosen and described to best explain the principles of the invention and its practical applications, thereby enabling others skilled in the art to understand the invention for use with various embodiments and with various modifications as suited to a particular use contemplated. It is intended that the scope of the invention be defined by the following claims and their equivalents.

What is claimed is:

1. A motion detecting device comprising:
a first detecting unit that detects a state of a writing hand of a writer that holds a writing instrument, based on first data output depending on the state of the writing hand from a first sensor provided independently of the writing instrument;
a second detecting unit that detects a distance between the writer and a recording medium on which information is written by the writer, based on second information output from a second sensor provided independently of the recording medium;
a determining unit that determines that the writer is writing on the recording medium when the state of the writing hand detected by the first detecting unit is a predetermined state and the distance detected by the second detecting unit is smaller than or equal to a predetermined threshold value; and
an output data generating unit that generates output data based on a state of the writer determined by the determining unit.

2. The motion detecting device according to claim 1, wherein:
the first detecting unit detects an angle of inclination of the writing hand with respect to a vertical direction based on the first data; and
if the angle of inclination detected by the first detecting unit is smaller than or equal to a threshold angle, and the distance detected by the second detecting unit is smaller than or equal to the threshold value, the determining unit determines that the writer is writing on the recording medium.

3. The motion detecting device according to claim 2, wherein:
the recording medium includes a first recording medium and a second recording medium; and
if the angle of inclination detected by the first detecting unit is smaller than or equal to the threshold angle, and the distance detected by the second detecting unit is smaller than or equal to the threshold value, the determining unit determines that the writer is writing on the first recording medium; and
if the angle of inclination detected by the first detecting unit is greater than the threshold angle, and the distance detected by the second detecting unit is smaller than or equal to the threshold value, the determining unit determines that the writer is writing on the second recording medium.

4. The motion detecting device according to claim 3, wherein:
the first detecting unit detects the angle of inclination, and also detects a writing motion based on a pattern of the first data representing a writing motion of the writer; and
if the writing motion is detected, the detected angle of inclination is smaller than of equal to the threshold angle, and the distance detected by the second detecting unit is smaller than or equal to the threshold value, the determining unit determines that the writer is writing on the first recording medium.

5. The motion detecting device according to claim 1, further comprising an identifying unit that identifies the writer a state of whose writing hand is a subject detected by the first detecting unit, and for which a distance between the writer and the recording medium is detected by the second detecting unit, wherein
the determining unit varies the threshold value depending on the writer identified by the identifying unit.

6. The motion detecting device according to claim 2, further comprising an identifying unit that identifies the writer a state of whose writing hand is a subject detected by the first detecting unit, and for which a distance between the writer and the recording medium is detected by the second detecting unit, wherein
the determining unit varies the threshold value depending on the writer identified by the identifying unit.

7. The motion detecting device according to claim 3, further comprising an identifying unit that identifies the writer a state of whose writing hand is a subject detected by the first detecting unit, and for which a distance between the writer and the recording medium is detected by the second detecting unit, wherein
the determining unit varies the threshold value depending on the writer identified by the identifying unit.

8. The motion detecting device according to claim 4, further comprising an identifying unit that identifies the writer a state of whose writing hand is a subject detected by the first detecting unit, and for which a distance between the writer and the recording medium is detected by the second detecting unit, wherein
the determining unit differentiates the pattern depending on the writer identified by the identifying unit.

9. A recording system comprising:
a first sensor unit that is provided independently of a writing instrument used by a writer;
a second sensor unit that is provided independently of a recording medium on which information is written by the writer;
a first detecting unit that detects a state of a writing hand of the writer that holds the writing instrument, based on first data output depending on the state of the writing hand from the first sensor;
a second detecting unit that detects a distance between the writer and the recording medium, based on second information output from the second sensor;
a determining unit that determines that the writer is writing on the recording medium when the state of the writing hand detected by the first detecting unit is a predetermined state and the distance detected by the second detecting unit is smaller than or equal to a predetermined threshold value;
an output data generating unit that generates output data based on a state of the writer determined by the determining unit;
an acquiring unit that acquires information written on the recording medium by the writer; and
a memory that stores information based on the output data generated by the output data generating unit, wherein
the output data generating unit generates the output data based on the information acquired by the acquiring unit and the determined state only when the state of the writer determined by the determining unit is a predetermined state; and
the memory stores the information acquired by the acquiring unit and the state determined by the determining unit on the basis of the output data generated by the output data generating unit.

10. The recording system according to claim 9, wherein:
the first detecting unit detects an angle of inclination of the writing hand with respect to a vertical direction based on the first data; and
if the angle of inclination detected by the first detecting unit is smaller than or equal to a threshold angle, and the distance detected by the second detecting unit is smaller than or equal to the threshold value, the determining unit determines that the writer is writing on the recording medium.

11. The recording system according to claim 10, wherein:
the recording medium includes a first recording medium and a second recording medium; and
if the angle of inclination detected by the first detecting unit is smaller than or equal to the threshold angle, and the distance detected by the second detecting unit is smaller than or equal to the threshold value, the determining unit determines that the writer is writing on the first recording medium; and
if the angle of inclination detected by the first detecting unit is greater than the threshold angle, and the distance detected by the second detecting unit is smaller than or equal to the threshold value, the determining unit determines that the writer is writing on the second recording medium.

12. The recording system according to claim 11, wherein:
the first detecting unit detects the angle of inclination, and also detects a writing motion based on a pattern of the first data representing a writing motion of the writer; and
if the writing motion is detected, the detected angle of inclination is smaller than of equal to the threshold angle, and the distance detected by the second detecting unit is smaller than or equal to the threshold value, the determining unit determines that the writer is writing on the first recording medium.

13. The recording system according to claim 9, further comprising an identifying unit that identifies the writer a state of whose writing hand is a subject detected by the first detecting unit, and for which a distance between the writer and the recording medium is to be detected by the second detecting unit, wherein
the determining unit varies the threshold value depending on the writer identified by the identifying unit.

14. The recording system according to claim 10, further comprising an identifying unit that identifies the writer a state of whose writing hand is a subject detected by the first detecting unit, and for which a distance between the writer and the recording medium is to be detected by the second detecting unit, wherein
the determining unit varies the threshold value depending on the writer identified by the identifying unit.

15. The recording system according to claim 11, further comprising an identifying unit that identifies the writer a state of whose writing hand is a subject detected by the first detecting unit, and for which a distance between the writer and the recording medium is to be detected by the second detecting unit, wherein
the determining unit varies the threshold value depending on the writer identified by the identifying unit.

16. The recording system according to claim 12, further comprising an identifying unit that identifies the writer a state of whose writing hand is a subject detected by the first detecting unit, and for which a distance between the writer and the recording medium is to be detected by the second detecting unit, wherein
the determining unit differentiates the pattern depending on the writer identified by the identifying unit.

17. A computer readable medium storing a program causing a computer to execute a process for detecting a motion, the process comprising:
detecting a state of a writing hand of a writer that holds a writing instrument, based on first data output depending on the state of the writing hand from a first sensor provided independently of the writing instrument;
detecting a distance between the writer and a recording medium on which information is written by the writer, based on second information output from a second sensor provided independently of the recording medium;
determining that the writer is writing on the recording medium when the detected state of the writing hand is a predetermined state and the detected distance is smaller than or equal to a predetermined threshold value; and
generating output data based on a state of the writer determined.

18. A motion detecting method comprising:
detecting a state of a writing hand of a writer that holds a writing instrument, based on first data output depending on the state of the writing hand from a first sensor provided independently of the writing instrument;
detecting a distance between the writer and a recording medium on which information is written by the writer, based on second information output from a second sensor provided independently of the recording medium;
determining that the writer is writing on the recording medium when the detected state of the writing hand is a predetermined state and the detected distance is smaller than or equal to a predetermined threshold value; and
generating output data based on a state of the writer determined.
